(19) United States
(12) Patent Application Publication
(10) Pub. No.: US 2010/0262505 A1
(43) Pub. Date: Oct. 14, 2010

(54) Method of buying and selling a promotional product or service

(76) Inventor: Jon G. Fields, Stoddard, WI (US)

Correspondence Address: WILHELM LAW SERVICE, S.C., 100 W LAWRENCE ST, THIRD FLOOR, APPLETON, WI, 54911, US

(21) Appl. No.: 12/384,925

(22) Filed: Apr. 10, 2009

(51) Int. Cl. G06Q 30/00; G06Q 40/00; G05B 15/02; H04M 1/00

(52) U.S. Cl. 705/26; 705/39; 700/83; 455/550.1

(57) ABSTRACT

A method of buying and selling a promotional product or service is disclosed. The method includes identifying potential buyers who are willing to seek such promotional products or services. Each of the potential buyers having a communication device that is connected to a communication system. Identifying sellers who are willing to offer a promotional product or service and having each input specific information into a computerized database. The computerized database is capable of receiving, storing and distributing selected information, on a real time basis, to the potential buyers when they access the database through their communication devices. The method further includes having the database tabulate the information and generate a report to each of the sellers indicating that a potential buyer accessed the computerized database to review a promotional product or service and recording when a potential buyer is actually bought a promotional product or service from one of the sellers.

### FIELD OF THE INVENTION

This invention relates to a method of buying and selling a promotional product or service.

### BACKGROUND OF THE INVENTION

In today's economic environment, potential buyers are looking for ways to save money while purchasing needed products and/or services. One way to accomplish this is for a potential buyer to buy a product and/or service that is being promoted at a price below a regular list price. Likewise, sellers of various products and/or services are looking for ways to generate increased sales and more customer traffic into their business establishments. Many sellers are offering short term, limited time sales and promotions in order to do this.

It is anticipated that the current economic environment will cause potential buyers to develop long term buying habits which will favor buying products and/or services that are on sale or being offered as special promotions in order to obtain the best possible price. It has also been recognized that many potential buyers are becoming more comfortable with using the latest communication devices, such as cell phones, smart phones, computers, laptops, notebooks, handheld devices such as Blackberry's personal digital assistant (PDA), the Internet, as well as various search engines like GOOGLE, YAHOO, etc, for visiting web sites, to find sellers who are offering sales and promotions on specific products and/or services. Such sellers can be local or distantly located merchants, retailers, wholesalers, manufacturers, jobbers, agents, individuals, etc., as well as professionals such as accountants, attorneys, tax preparers, doctors, dentists, personal trainers, lawn service operators, snow removal services, etc. The potential buyers can use a computer to surf the internet twenty-four hours a day, seven days a week from almost any location to find the best deals.

It has also been recognized that a potential buyer can now purchase a product and/or service in various ways. One way is for a potential buyer to make a face to face visit to a local store and buy a displayed product. Examples of this include a potential buyer visiting an automobile dealership and purchasing a car or truck that is parked on the lot, or visiting a restaurant and ordering a meal off of a menu. A second way is for a potential buyer to use a computer and go online via the Internet to find and purchase a product or service. The product can be shipped to the buyer's home or office within a matter of days using the postal service or some other parcel post carrier, such as United Parcel Service (UPS). To encourage such on-line purchases, some sellers are even offering free shipping when the purchase price exceeds a certain dollar amount. In the case of a service, a potential buyer can arrange for a business service, such as a grass cutting service, a snow removal service, a lawn care service, etc. to send their employees to a particular address on a designated date and at a specified time to perform the needed service. This added convenience is causing more and more people to shop online. A third way for a buyer to purchase a product and/or service is to use a telephone. The potential buyer can dial a seller directly and ask them to either set aside a product or to ship a particular product to them. The potential buyer can pay for the product or service with a credit card by providing the seller with the name of the issuing credit card company, i.e. VISA, MASTERCARD, etc. and the credit card number over the phone. A fourth way for a potential buyer to purchase a product is to turn on a television and watch a channel which is offering merchandise for sale. Many jewelry items, such as necklaces, bracelets, rings, watches, pendants, etc. are sold this way. The potential buyer merely calls a displayed telephone number on the TV screen and purchases the product with a credit card. The goods are shipped immediately via the postal service or a parcel post carrier.

As new technologies in the communication field are developed and made available to potential buyers, more and more potential buyers will find it easier to purchase products and/or services from the comforts of their surroundings and at a time of their choosing.

Now, a method of buying and selling a promotional product or service at a price below a regular list price has been invented. The method benefits the potential buyers, the sellers of a promotional product or service, a communication service provider, a database owner, a credit card company and a transaction processing company.

### SUMMARY OF THE INVENTION

Briefly, this invention relates to a method of buying and selling a promotional product or service at a price below a regular list price. The method includes the steps of identifying a potential buyer who is willing to seek a promotional product and/or service at a price below a regular list price. The potential buyer has or is issued a communication device that can be activated. The communication device is connected to a communication system. The communication system is owned, operated or controlled by a communication service provider who has contractually agreed with the potential buyer to provide a connection covering a specific geographical area. The communication service provider can also supply the communication device to the potential buyer. The method also includes identifying a seller who is willing to sell a promotional product and/or service at a price below a regular list price. The seller has contractually agreed with the communication service provider or with a database owner to input specific information into a computerized database relating to his or her promotional product and/or service. The computerized database is capable of receiving and storing specific information, and distributing selected information over the communication system, on a real time basis, to the potential buyer when prompted by the activated communication device. The computerized database can tabulate information indicating when a potential buyer accessed the computerized database to review a promotional product and/or service offered by the seller. The computerized database can also report to the seller when the potential buyer actually bought a promotional product and/or service. Any of the tabulate information is made available to the seller.

The general object of this invention is to provide a method of buying and selling a promotional product or service at a price below a regular list price. A more specific object of this invention is to provide a method of identifying potential buyers and sellers who are willing to buy and sell a promotional product or service, respectively, at a price below a regular list price, and providing each potential buyer with a communication device which can be activated so as to be connected to a communication system, and which can be used to connect each potential buyer to a computerized database which can distribute selected information about a promotional product or service to each buyer.

Another object of this invention is to provide a method which includes issuing a credit card to each buyer which can be used to buy a promotional product or service offered by a particular seller at a price below a regular list price.

A further object of this invention is to provide a method which allows a potential buyer to access a computerized database using a wireless communication device to view and possibly purchase a promotional product or service at a price below a regular list price.

Still another object of this invention is to provide a method which generates a report indicating when a potential buyer accessed the computerized database to review a promotional product or service offered by a seller and to record when the potential buyer actually bought the promotional product or service from the seller.

Still further, an object of this invention is to provide a method of buying and selling a promotional product or service at a price below a regular list price, which allows a communication service provider to supplement information distributed by a computerized database to a potential buyer with a printed publication.

Other objects and advantages of the present invention will become more apparent to those skilled in the art in view of the following description and the accompanying drawings.

### BRIEF DESCRIPTION OF THE DRAWINGS

FIG. 1 is a schematic showing the parties and equipment needed to practice the method of buying and selling promotional products or services.

FIG. 2 is a schematic showing the initial input of a promotional offer by a seller.

FIG. 3 is a schematic showing one way to use the method to make a purchase using the communication device.

FIG. 4 is a schematic showing an alternative way to use the method to make a purchase using a computer and the Internet.

FIG. 5 is a schematic showing of third alternative way to use the method to make a purchase using a vehicle display and a vehicle communication interface.

FIG. 6 is a schematic showing a fourth alternative way to use the method to make a direct purchase while still obtaining the promotional price.

FIG. 7 is a schematic showing the billing and collection portion of the method.

FIG. 8 is a schematic showing the financial distribution and reporting portion of the method.

FIG. 9 is a schematic showing a positive outcome for all the parties using the method of buying and selling a promotional product or service.

### DETAILED DESCRIPTION OF THE INVENTION

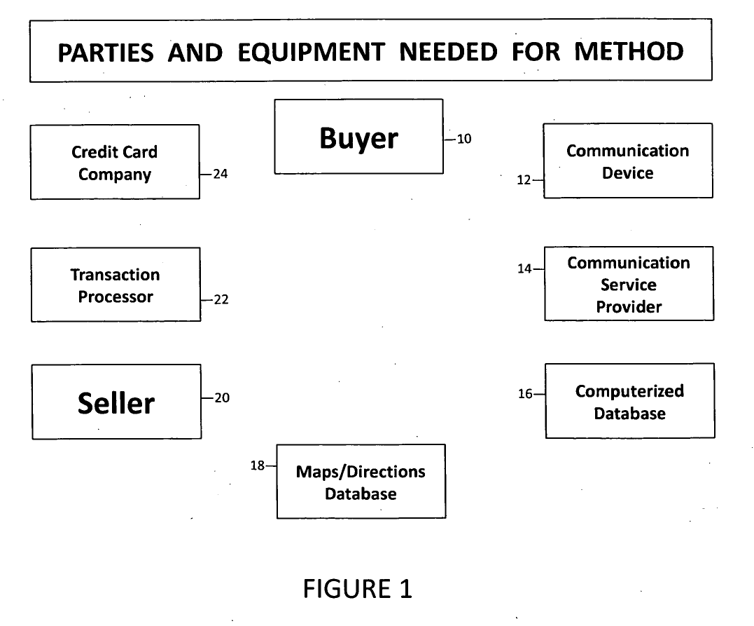

Referring to FIG. 1, a schematic is shown which depicts the elements involved in the method of buying and selling a promotional product or service. A business process is a collection of related, structural activities or tasks that produce a specific product or service, serve a particular goal for a particular customer or customers. There are three types of business processes. The first is a management process, the second is an operational process and the third is a supporting process. The management process includes processes that govern the operation of a system. Typical management processes include corporate governance and strategic management. The operational processes include processes that constitute the core business and create the primary value stream. Typical operational processes include purchasing, manufacturing, marketing and sales. The supporting processes support the core operational processes and include such functions as accounting, legal, recruitment, technical support, etc.

A business process begins with a customer's need and ends when the customer's need is fulfilled. Process oriented organizations break down the barriers of structural departments and try to avoid functional silos. A business process can be divided into several sub-processes. Each process can have its own attributes but also functions to contribute to achieving the goal of the entire business process. The analysis of a typical business process includes the mapping of processes and sub-processes down to an activity level.

A business process is designed to add value for the customer and should not include unnecessary activities. The outcome of a well designed business process is increased effectiveness (value for the customer) and increased efficiency (less costs for the company). Business processes can be modeled through a large number of methods and techniques.

The method of buying and selling a promotional product or service is aligned with current trends. This method capitalizes on the current economic environment and the long-term buying habits that will be developed from the tight economy experience. Sellers, including but not limited to: individuals, merchants, retailers, wholesalers, middlemen, agents, jobbers, manufacturers, etc., are looking for ways to generate increased customer traffic and are using short-term, limited-time sales and promotions to do so. Buyers, including but not limited to: individual consumers buying for their own needs as well as business buyers who are purchasing goods and services on behalf of a business, company or corporation, are looking for the best possible values. The method of buying and selling a promotional product or service also capitalizes on the fact that potential consumer buyers and potential business buyers are becoming more and more comfortable using available electronic technologies for information searches and purchases.

It should be understood that marketing professionals often differentiate between “promotions” and “advertisements”. As used herein, by “promotions” it is meant messages from a seller to one or more potential buyers designed to elicit a buying response within the immediate future or within a specified time. Promotions may offer a reduced price or value-added offer (discount, sale, coupon, etc.) for a specific period of time (during certain hours, days, weeks, etc.). By “advertisements” it is meant messages from a seller to one or more potential buyers designed to increase awareness and interest in products and/or services that are available from sellers. Each potential buyer is not offered a time-limited value incentive to act quickly or within a specified period of time.

The method of buying and selling a promotional product or service provides a new way for a potential buyer or a plurality of potential buyers to learn what a seller or a plurality of sellers have to offer in the form of limited-time promotions (sales, coupons, specials, discounts, etc.). The potential buyer(s) then acts upon that information to make a purchase at a reduced price thereby obtaining a better value. The method of buying and selling a promotional product or service can further be used to make a purchase within the immediate future or to make a purchase for consumption sometime in the future, for example, making reservations at a restaurant to be seated and served on an upcoming date. The method of buying and selling a promotional product or service can also be used to purchase inexpensive items, for example, sandwiches, grocery items, a cup of coffee, etc., or expensive items, for example, automobiles, trucks, pleasure boats, furniture, jewelry, airline tickets, cruise tickets, hotel reservations, etc. The method of buying and selling a promotional product or service can further be used to make purchases face-to-face between a potential buyer and a seller or it can be used to make purchases from a remote location using various electronic information technologies, such as cell phones, smart phones, computers, laptops, notebooks, etc. The purchases can be made between domestic and/or international buyers and sellers.

Still referring to FIG. 1, the schematic depicts the required parties or elements needed for carrying out the method of buying and selling a promotional product or service. The first thing needed is a potential buyer 10. One buyer 10 is shown but it should be understood that the method is designed for use by a plurality of buyers 10. Hundreds, thousands and even millions of buyers 10 can be signed up to participate in this method. A potential buyer 10 can be an individual, a household, a group, an organization, a business, etc. The potential buyer 10 must be willing to seek a promotional product or service at a price below a regular list price. Each potential buyer 10 has access to a communication device 12. The communication device 12 does not have to be owned or controlled by each buyer 10 but must be available to each buyer 10. The actual ownership of the communication device 12 is not important although it is common for each potential buyer 10 to own his own communication device 12. Desirably, each buyer 10 possesses a communication device 12 or has access to a communication device 12. The communication device 12 can vary in design, construction and/or function. The communication device 12 can be fixed in a set location, be fixed to a movable object or be mobile. Desirably, the communication device 12 is a mobile device weighting only a few ounces and having a maximum dimension of less than about 4 inches. The communication device 12 can be a wireless device wherein it intercepts a signal which is carried through the air. Desirably, the communication device 12 is a relatively small, mobile wireless device that can easily be transported by a buyer 10. Alternatively, the communication device 12 is hard wired to an electrical connection, such as by a phone line or audio cable.

The communication device 12 can also include a mechanism, such as an on and off switch, such that the potential buyer 10 can activate or deactivate the device 12. The communication device 12 has to be activated before it will operate. It is not necessary that the communication device 12 be activated or turned on at all times. In fact, it may be desirable to deactivate the communication device 12 at some time.

The communication device 12 can also include other features including but not limited to: a key pad, a viewer screen, a combination of a key pad and a viewer screen, a global positioning system (GPS), a voice recognition system, etc. As stated above, the communication device 12 can be a mobile device that is fixed to a particular object. For example, the communication device 12 can be mounted inside of an automobile or truck, be mounted in an airplane or on a train, be mounted on a boat, etc.

The communication device 12 can include but is not limited to: a cell phone, a smart phone, a wrist phone, a display unit mounted inside a movable vehicle, a computer, a laptop, a notebook or other electronic device, a hand held communication device such as a Palm Pilot® or a Blackberry®), etc. The communication device 12 can further include software that will provide map and directional assistance, voice recognition capabilities, etc.

It should be understood that it is the potential buyer 10 who has the ability to activate or deactivate the communication device 12 when so desired. By “activate” it is meant the ability to turn on, make active, to set in motion. By “deactivate” it is meant the ability to turn off, render inactive, ineffective or inoperative, temporarily or permanently inhibit, block or disrupt an action. The potential buyer 10 also has the ability to intermittently activate or deactivate the communication device 12. By “intermittently” it is meant stopping and starting at intervals; to suspend or cause to suspend activity temporarily or periodically.

The communication device 12 will usually contains a power source, such as a battery. The power source may need to be recharged periodically depending upon the amount of time the communication device 12 is activated and being used. The power source can be recharged by plugging or attaching the communication device 12 into an electrical outlet via an electrical cord. Alternatively, the communication device 12 can be directly connected to an electrical outlet. While being recharged, the communication device 12 can still be used.

Still referring to FIG. 1, another needed party to the method is a communication service provider 14. The communication service provider 14 can include but is not limited to: a business organization, a company, a corporation, a division or a department that has the means and equipment necessary to connect multiple communication devices 12 to a communication system. For example, the communication service provider 14 can be a telecommunication company such as AT&T, Verizon, T-Mobile, Bell South, etc. which owns, operates or controls satellites, towers, relay equipment, amplifying equipment, as well as other mechanisms known to those skilled in the art, for sending, routing, storing and/or receiving radio waves, digital signals, digital information, or other broad band frequencies. The communication service provider 14 can enter into various legal contracts, agreements or licenses to use such required equipment or it can own such equipment outright. In addition, the communication service provider 14 can issue a communication device 12 to each potential buyer 10 who signs a contract with it.

Each potential buyer 10 will enter into a contractual agreement with the communication service provider 14 whereby each potential buyer 10 will pay, for example a monthly service fee, for being connected to the communication system. The communication service provider 14 will send an invoice, i.e. a monthly invoice, to each potential buyer 10 for being connected to its communication system even if the potential buyer 10 does not actually use the communication system for a specified period of time, i.e. monthly. The contractual agreement will allow each potential buyer 10 to have his or her communication device 12 be connected to the communication system operated by the communication service provider 14. The connection can be through the airwaves for a specific geographical area. Desirably, the connection is a wireless connection although it could be a hard wire connection. The connection can be available twenty-four hours a day, each day of the year. The contractual agreement can extend for a specified period of time, for example, for one or more years and could automatically be renewable unless terminated in writing.

The specific geographical area over which the communication service extends can vary in size and location. The geographical area could include a small defined area limited to a specific building or to two or more buildings. Alternatively, the geographical area could include one or more square miles or could include a certain district or city. Still further, the geographical area could include an individual county, a state, a region, or cover an entire country. Likewise, the geographical area could include two or more countries or portions of two or more countries. Still further, the geographical area could include an area encompassing an entire continent or the entire surface area of the earth.

Still referring to FIG. 1, another needed element is a computerized database 16. Desirably, the computerized database 16 is capable of receiving, storing and distributing large amounts of information and data quickly and efficiently. The computerized database 16 is capable of receiving and storing information relating to current and future promotions of products and/or services, including but not limited to: specific products, specific services, promotions, time of the promotions, sales, discounts, coupons or other special offers that can be distributed or be made available to one or more of the potential buyers 10. The computerized database 16 can be owned, operated or controlled by the communication service provider 14. Alternatively, the computerized database 16 can be owned, operated or controlled by an independent third party. The computerized database 16 can receive and store a vast amount of other information relating to a promotional product or service, such as the regular price of a product or service that is being promoted, the particular terms of a promotional product or service, the number of promotional products or services that are available, etc.

The computerized database 16 can include the software and capabilities to provide map and directional information to a potential buyer 10. Alternatively, the computerized database 16 can be connected to a map/directions database 18 which has the ability to provide maps and/or directional information to the potential buyers 10. The map/directions database 18 should also be a computerized database. In the schematic, the second database 18 is depicted as being separate and distinct from the computerized database 16. Since the second database 18 contains specialized and sophisticated software designed specifically to provide maps and directional information, as well as global positioning information, the second database 18 is usually operated by an independent party that is not affiliated with the operator of the computerized database 16. If this is the case, then the operator or owner of the computerized database 16 can contractually agree with the operator or owner of the second database 18 to use their database when required. These added features enable the computerized database 16 to provide the potential buyers 10 with an easy way to located and find a seller 20.

The map/directions database 18 can be electrically connected to the computerized database 16 by equipment known to those skilled in the art. Alternatively, the map/directions database 18 can be constructed as part of the computerized database 16. The map/directions database 18 can provide the buyer 10 with GPS coordinates and location of where he or she is currently situated as well as provide the buyer 10 with maps and directions as to how to navigate so as to arrive at the seller's 20 business. The map and directional information along with GPS coordinates can be displayed on a viewer screen or a visual monitor which is made a part of the buyer's communication device 12.

Still referring to FIG. 1, another required party to the method of buying and selling a promotional product or service, is the seller 20. Desirably, a plurality of sellers 20 will be involved. Each of the sellers 20 can be an individual, a merchant, a retailer, a wholesaler, a middleman, an agent, a jobber, a manufacturer, etc. Each of the sellers 20 must be willing to sell a promotional product or service at a price below a regular list price. Each of the sellers 20 has the capability of selling more than one promotional product and/or service at any given time, if desired. Each of the sellers 20 can offer his promotional product or service to a prospective consumer buyer 10 (business-to-consumer) or to a business (business-to-business) buyer 10. Each of the sellers 20 will contractually agree with the owner, operator or controller of the computerized database 16 to input specific information into the computerized database 16 relating to at least one promotional product or service offered by each of the sellers 20. The way a seller 20 can input information into the computerized database 16 can vary. For example, each of the sellers 20 can directly or indirectly input specific information into the computerized database 16. For example each of the sellers 20 can use a computer and connect to the computerized database 16 via the Internet. Once connected, each of the sellers 20 can input specific information into the computerized database 16. Alternatively, each of the sellers 20 could phone, fax, text, e-mail, etc. his or her specific information into the computerized database 16 and a person working for the computerized database 16 can input the specific information. Another alternative is to have each of the sellers 20 mail his specific information into the computerized database 16. Still other ways of inputting specific information into the computerized database 16 will be known to those skilled in the art.

Such inputted information will normally include the name, address, phone number, fax number and e-mail address of each of the sellers 20. Additionally, each of the sellers 20 can input information relating to his or her promotional products and/or services which are being offered for sale, the days and hours his or her business is open, the location of his or her business, whether more than one business location exist, if all of his or her businesses are participated in the promotional offer, etc. Other information can also be inputted. Such information can include but is not limited to: availability of handicap access, if pets are welcome, a current business rating, a Better Business Bureau recommendation, whether smoking is permitted on the premises or if the business is a non-smoking site, whether any foreign languages are spoken by the staff, for example: “English and Spanish spoken here”, information on a family friendly environment, comments and compliments from previous buyers, information on the business's reputation for quality and/or timely service, information on ethical reputation, information on any pending law suits or criminal complaints against the business, employees opinions, environmental position of the business, etc. Additional information could also alert a potential buyer 10 if the business is located in a certain time zone, is affected by daylight saving time changes, if more than one currency is accepted, if different kinds of credit cards are accepted, etc. If the seller 20 operates a restaurant, the additional information could also include take out service, menus, types of food dishes sold, the ability of a buyer 10 to order a food dish which can be eaten by a person who may be suffering from a food disorder, a person who is a vegetarian, a person who requires a gluten free menu, a person who is on a salt free diet, a person who has diabetics or some other medical problem. Additional information could also disclose handicap seating arrangements that are available, age requirements in order to order alcoholic drinks, whether a photo identification is required before a person is admitted into a bar or drinking establishment, whether a patron can bring his own alcohol onto the premises, etc.

Each of the sellers 20 can also input specific information into the computerized database 16, such as a registration number or code, which is required for receiving payment or credit for promotional products or services that will be sold. This information can be blocked so that it will not be available to potential buyers 10. In other words, each potential buyer 10 will only be able to receive select information from the computerized database 16. By “select information” it is meant information designated by the owner or operator of the computerized database 16 which will be available to the potential buyers 10. The owner or operator of the computerized database 16 will control what select information is disseminated or distributed to each potential buyer 10. Some examples of the kind of information that can be blocked includes but is not limited to: the name of a bank that the seller 20 uses, a seller's 20 bank account 3o number, a seller's 20 tax number, a seller's 20 special codes used to electronically transfer money, etc.

As recited above, each of the sellers 20 can input his or her data directly or indirectly into the computerized database 16. For example, each of the sellers 20 could electronically connect to the computerized database 16 via a computer and the Internet, and input the specific or desired information by typing it in. Alternatively, each of the sellers 20 could phone, fax, text or e-mail in the desired information. Another option is for each of the sellers 20 to meet face-to-face with a person who works for the owner, operator or controller of the computerized database 16 and have them enter the information.

The computerized database 16 is designed to easily and quickly receive, record and store large amounts of information such that each of the sellers 20 can input. Multiple sellers 20 can input their information simultaneously into the computerized database 16. The computerized database 16 is also capable of disseminating, distributing or sending select information out to a plurality of potential buyers 10 simultaneously or sequentially. Desirably, the computerized database 16 will be automated to the point where it can send out select information to multiple potential buyers 10 at the same time. More desirably, hundreds or even thousands of buyers 10 will be able to access information from the computerized database 16 at the same time. The select information that is distributed by the computerized database 16 is transmitted over the communication system on a real time basis to each of the potential buyers 10. The select information is only sent out when a potential buyer 10 activates his or her communication device 12. This is important because today many potential buyers 10 are inundated and overwhelmed with junk mail. Such junk mail may not relate to anything they are even remotely interested in. The present method differs in that it is the buyer 10 who contacts the computerized database 16 and downloads the select information to his or her communication device 12. No information is randomly pushed out to the potential buyers 10 by the computerized database 16.

Still referring to FIG. 1, it should be understood that the computerized database 16 has the ability to electronically tabulate information and/or generate a written or electronic report for each seller 20 indicating that a potential buyer 10 has accessed the computerized database 16 to review a promotional product or service being offered for sale by a particular seller 20. The tabulate information can also record when and/or that a potential buyer 10 actually bought a promotional product or service from a particular seller 20. Furthermore, the tabulate information could compile and report statistics and demographic profiles (age, income, race, education, marital status, geographic, etc.) and psychographic profiles (hobbies, interests, lifestyles, etc.) of potential buyers 10 who accessed the seller's information and statistics and demographic and psychographic profiles of buyers 10 who actually made a purchase. The tabulate information can be made available to each of the sellers 20 on a regular basis, such as once a day, once a week, once a month, once a quarter, etc. Alternatively, the tabulate information can be assembled into a written, printed or electronic report. The report could be generated when a certain number of inquiries or hits have been met and then can be sent to each of the sellers 20. For example, a report could be generated once ten inquiries or hits have been recorded. The tabulate information and/or the report could also record additional information which a particular seller 20 may be interested in. For example, the tabulate information and/or report could identify if the potential buyer 10 was a male or a female, the time of day or night that the potential buyer 10 accessed the seller's 20 data, the particular store where a purchase occurred if the seller 20 has two or more stores, the particular day of a week or the day of a month that the potential buyer 10 accessed the seller's 20 data, etc.

Once the tabulate information is available or a report has been generated, it can be made available to each of the sellers 20 so that each seller 20 can connect with the computerized database 16 and retrieve the tabulated information and/or report. Alternatively, the tabulate information and/or report can be electronically sent to each of the sellers 20. Another option is to print the report and then mail, send or deliver the report to the seller 20. This last method will assure that each seller 20 will have a hard copy which they may wish to retain for future reference. Still another option is to phone or electronically fax, text, e-mail, or use other known means to send the tabulate information and/or report to each of the sellers 20.

The tabulate information and/or report can be accumulated and/or generated in real time, on a minute or hourly basis, or it can be generated at a set time, such as the last business day of each month. The tabulate information and/or report could identify each promotional product and/or service offered by each of the sellers 20. The owner, operator or controller of the computerized database 16 could also review the recorded information and offer additional advice relative to the recorded information. For example, if the promotional products and/or services offered by a particular seller 20 did not produce satisfactory results, the owner, operator or controller of the computerized database 16 could offer suggestions and comments for improving the seller's 20 next promotional product and/or service offering.

Still referring to FIG. 1, another needed party to the method is a transaction processor 22. The transaction processor 22 can be an independent entity, such as a company, a department of a company, an organization, a division, an individual, etc. that is set up to process the financial transactions between the buyers 10 and the sellers 20. The transaction processor 22 could also have the ability to collect and distribute fees between the various parties. Such fees will be contractually agreed to in advance of setting up the present method.

Lastly, the method includes a credit card company 24 which receives information and data from the transaction processor 22. The credit card company 24 can also be a credit company or a credit/debit card company. The credit card company 24 will issue a credit card or some other recognition device to each of the qualified, potential buyers 10 who have signed a contractual agreement with the communication service provider 14. Each potential buyer 10 has to be approved by the credit card company 24 even if he or she has already signed the contractual agreement with the communication service provider 14 before he or she can obtain a credit card. In place of a credit card, each potential buyer 10 can be recognized by a computer chip encoded with personal information, by an iris recognition system, by a fingerprint recognition system, by a thumb print recognition system, by a hand print recognition system, or by some other identification device or system known to those skilled in the art. The identification device or system can be implanted or be made a part of an object or device which the buyer 10 comes into contact with.

For the purpose of describing this invention, let's assume that each qualified buyer 10 receives a credit card. The future acceptance of the credit card for a purchase of a promotional product or service can be limited to only those sellers 20 who have contractually agreed to participate with the owner, operator or controller of the computerized database 16. The credit card company 24 can contract with the communication service provider 14 or with the owner or operator of the computerized database 16 to provide a credit card to each of the plurality of potential buyers 10. Once each of the potential buyers 10 has received a credit card, they will have a way to purchase a promotional product or service from one of the plurality of sellers 20 at a price below a regular list price. The credit card company 24 also is responsible for sending invoices to the buyers 10 on a regular basis, for example, once a month. The credit card company 24 is further responsible for collecting payments from each of the buyers 10 for all promotional products or services that were purchased. The credit card company 24 will distribute the appropriate funds to each of the sellers 20 for the products and services each has sold. The sellers 20 may be credited or actually receive a payment before the credit card company 24 actually receives payment from each of the buyers 10. If a payment is not eventually received from a particular buyer 10, then that amount may be debited from the seller's 20 account. The credit card company 24 will usually charge a fee for providing this service. The sellers 20 usually pay this fee. However, the fees due the credit card company 24 can be split between two or more of the parties. In addition, the credit card company 24 may also make appropriate credits and payments to the communication service provider 14, to the owners, operator or controller of the computerized database 16, and/or to the owners, operator or controller of the map/directional database 18. The credit card company 24 may also record, report and/or distribute reward points, coupons, dollars, etc. to the buyers 10 for each purchase made and/or to the sellers 20 for each product or service sold.

The credit card company 24 can own, operate or control the transaction processor 22, if desired. Some of the functions and duties of the credit card company 24 can overlap with the transaction processor 22. Alternatively, the credit card company 24 can contract with the transaction processor 22 who is capable of processing all financial transactions between each of the plurality of buyers 10 and each of the plurality of sellers 20. The transaction processor 22 then electronically reports each of the transactions to the credit card company 24. The credit card company 24 then prepares and sends an invoice to each of the buyers 10 on a regular basis who has made a purchase of any of the promotional or regular priced products or services from any of the plurality of sellers 20.

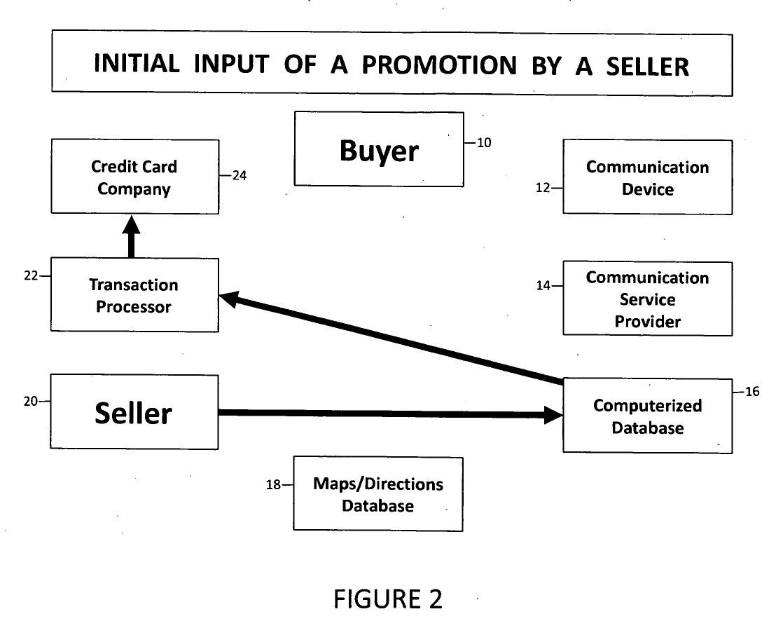

Referring to FIG. 2, a schematic is shown of an initial input of a promotional offer by a seller 20. The seller 20 inputs specific information into the computerized database 16. For the sole purpose of explaining this invention, the product selected will be carpeting. The seller 20, a carpet dealer, accesses the database 16 via various means, including but not limited to: using a computer and the Internet, using a telephone call, mailing in printed material, delivering information via a carrier, etc., so as to register a promotion on carpeting (sale, coupon, discount, etc.). The promotional information can relate to a general product category, i.e. carpeting in this example, as well as detailed product specifications pertaining to the carpeting, i.e. brand, make, model, etc., list and promotional prices, beginning and ending dates and times of the carpeting promotion, customer eligibility, i.e. available for all people with free transport within a 50 mile radius. Some promotions may be available to all potential buyers 10 while other promotions may be exclusively for those who are customers of the communication service provider 14 or some other group or organization, i.e. to all senior citizens.

This inputted promotional information is received by the computerized database 16 and is stored for a predetermined amount of time. Desirably, this information is kept for at least twelve months or as long as required by law or statute. The owner or operator of the computerized database 16 will report a promotional registration for each of the sellers 20 to the transaction processor 22. This will allow the transaction processor 22 to apply the correct discount to any future purchases made by buyers 10 of the seller's 20 promotional carpeting. The transaction processor 22 will then be able to forward the correct discounted purchase price on to the credit card company 24 at the appropriate time. The seller 20 may be charged a fee for this service, i.e. inputting the particular promotion.

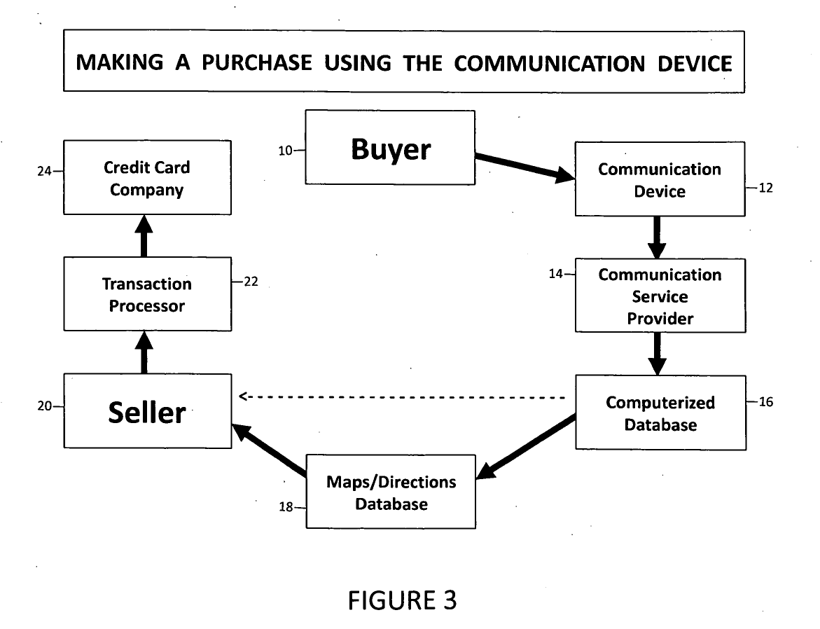

Referring now to FIG. 3, a schematic is shown detailing the purchase of a promotional product or service using the present method. The method begins when a potential buyer 10 is interested in finding out what promotional deals are available on carpeting. He or she can activate his or her communication device 12 and be connected to the computerized database 16 via the communication service provider's 14 communication system. The potential buyer 10 can do this by dialing, typing, texting, e-mailing, using voice recognition or voice activating equipment, work through an on-screen menu, etc. certain search requirements into his or her communication device 12. Once the buyer 10 accesses the computerized database 16, he or she will choose certain criteria for the search. For example, the potential buyer 10 can input information relating to a product category, i.e. “carpeting”. The potential buyer 10 can also input specific information pertaining to a special kind or type of carpeting, i.e. indoor carpeting, outdoor carpeting, carpeting having a certain ply, a particular color, etc. The potential buyer 10 can also input information relating to the location of a seller 20. For example, the potential buyer 10 may want to select all sellers 20 located within a five mile radius from his home. Upon receiving the search request, the computerized database 16 will identify those sellers 20 which meet the potential buyer's 10 criteria and send select information back to the potential buyer 10. In addition to the specific information requested by the potential buyer 10, the computerized database 16 can also send along additional select information. This select information can be the same as or different from the specific information entered by the seller 20. For example, the select information can include information that was earlier inputted by the sellers 20. This select information can also include one or more of the following items: a listing of the kinds and types of promotional products or services offered for sale by the seller 20, the location of the seller's 20 business, directions to the seller's 20 business from a current or set location, the time when the seller 20 is open for business, the time zone in which the seller's 20 business is located, a listing of credit cards accepted by the seller 20, a notice of any conditions imposed by the seller 20 which must be met by the potential buyer 10 to qualify for the promotional products or services, the amount of sales tax that is applicable, a notice of handicap accessibility to the seller's 20 business, a notice of a smoking/non-smoking policy at the seller's 20 business, a notice of whether a pet is permitted in the seller's 20 business, etc.

The computerized database 16 is able to provide the potential buyer 10 with a listing of all the sellers 20 who are offering a promotion on carpeting within the specific geographical area covered by the communication service provider 14 or those within the selected radius criteria inputted by the potential buyer 10. This promotional information is displayed on a viewer screen which is part of or is connected to the communication device which the potential buyer 10 controls. For example, the viewer screen can be a monitor connected to a computer or a screen on a cell phone. The promotional information is disseminated instantaneously over the airwaves or hard wired connections by the computerized database 16 and arrives in an easy to read format on the screen or monitor of the buyer's 10 communication device 12. If the potential buyer 10 needs maps and/or directions from his or her current location to the seller's 20 business, the potential buyer 10 can select the map/directions database 18 to obtain information on the best route to take to arrive at the seller's 20 business. The map and directional information will appear on the screen of the communication device 12 or on a computer monitor. If the potential buyer 10 does not need the maps/directions database 18, then the potential buyer 10 can skip this step as is indicated by the dotted line in FIG. 3.

The fact that a potential buyer 10 has accessed the computerized database 16 will be recorded by the computerized database 16 regardless of whether an actual purchase does in fact occur. This information will be reported to the seller 20 since it can be valuable information which the seller 20 will be interested in. For example, if a large number of potential buyers 10 access the computerized database 16 and receive a particular seller's 20 promotional information but they do not visit his store or make a purchase, it may alert the seller 20 that some other competitor is offering a more effective promotion. Armed with this information, the seller 20 will be able to adjust his or her next promotional offering to hopefully increase future sales.

Assuming a potential buyer 10 visited one of the seller's 20 businesses and actually makes a purchase of carpeting, the buyer 10 could pay for the purchase with cash, a check, with his or her issued credit card, with a prepaid credit card, with a debit card, with a credit card issued by another credit card company or with an in-store credit account. In the case that the promotional price is only available to subscribers of the communication service provider 14 and that have a valid credit card issued by the credit card company 24, the buyer 10 would have to pay with his or her issued credit card in order to get the promotional price. When the buyer 10 uses his or her issued credit card for the purchase, this purchase is electronically reported to the transaction processor 22. The transaction processor 22 in turn will electronically record and/or report the date and time of the purchase, the seller's 10 name, and the dollar amount of the purchase to the credit card company 24. The credit card company 24 will then proceed to invoice the buyer 10, usually on a monthly basis, and will credit the seller 20 with a credit or payment for each sale. The credit card company 24 will subtract a small fee for its services before crediting or paying the seller 20. Usually the seller 20 is credited or paid by the credit card company 24 before an actual payment is received from each of the buyers 10.

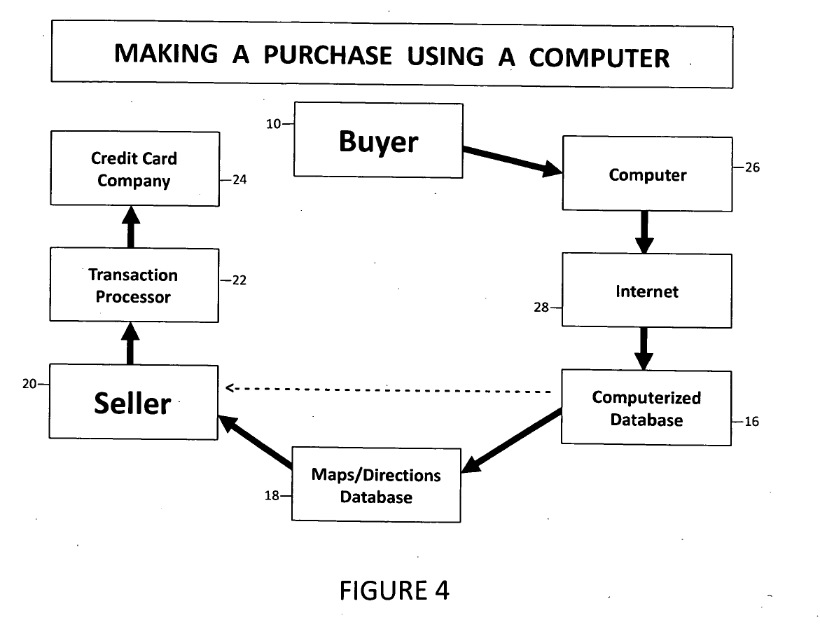

Referring to FIG. 4, a schematic is shown of an alternative way to access the computerized database 16. This alternative method includes the use of a computer 26 and an Internet provider 28. The potential buyer 10 will log into the Internet using a stationary or portable computer 26. The computer 26 can be in the form of a desktop computer, a laptop computer, a notebook, etc. The computer 26 can be hard wired to an electrical outlet or have wireless capability, such as a Wi-Fi connection. “Wi-Fi” is a registered trademark of Wireless Internet Compatibility Alliance. The potential buyer 10 can access the computerized database 16, for example, by typing in the domain name of the computerized database 16, to access the information he or she is interested in. The remainder of the method is the same as was described above with reference to FIG. 3.

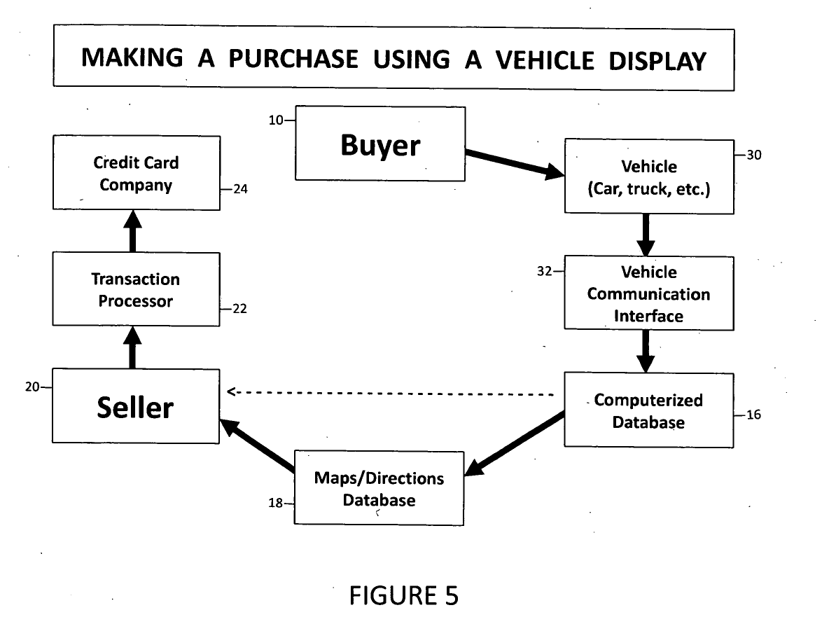

Referring to FIG. 5, a schematic is shown of still another alternative for accessing the computerized database 16. This alternative method includes the use of a vehicle display 30 and a vehicle communication interface 32. The vehicle display 30 includes a viewer screen or monitor. The potential buyer 10 will log into the vehicle display 30 using a key pad, touch screen, touch bottoms, or audio to activate the system. The vehicle display 30 is connected to the vehicle communication interface 32 which can access the computerized database 16 via a wireless connection. Once activated, the potential buyer 10 can input his or her desired search criteria. The search results will appear on the vehicle display 30. The remainder of the method is the same as was described above with reference to FIG. 3.

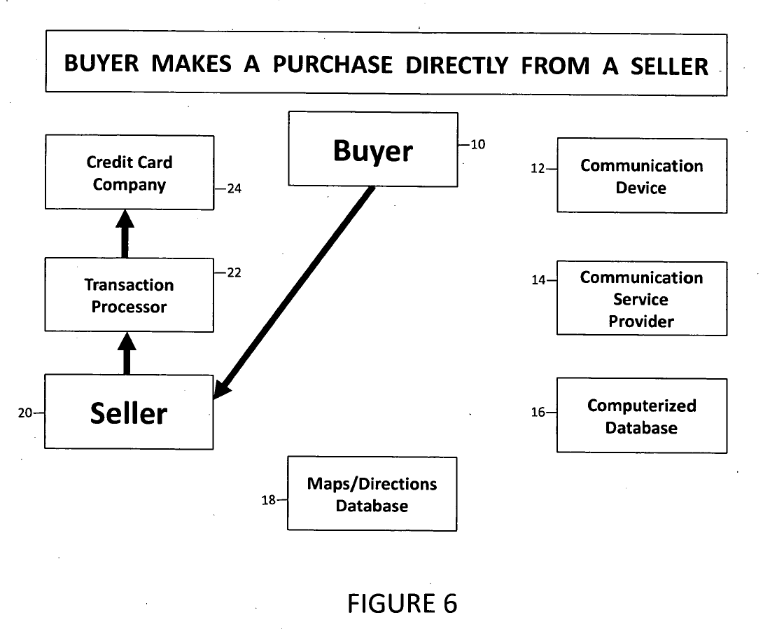

Referring to FIG. 6, a schematic is shown of a fourth way for making a purchase using the inventive method. In this alternative procedure, the buyer 10 makes a direct purchase from a seller 20 with or without advance knowledge that the seller 20 is offering a promotion on a particular product or service. The buyer 10 makes a face-to-face visit to one of the sellers 20 without the prompts or assistance of having used the communication device 12 or the computerized database 16. The buyer 10 may or may not be aware that the seller 20 is offering a promotional price. The purchased product or services may be the promotional product or service as well as another product or service sold at the regular retail price. The product or service purchased can be for immediate use or for future use, i.e. for a hotel, airline or restaurant reservation. When the buyer 10 uses his or her issued credit card to pay for the purchases, the transaction processor 22 will automatically apply the promotional price to any purchased products or services since this information is already in the system. Any buyer 10 who happens to purchase a product or service from a seller 20 who is offering a promotional price, using the issued credit card, will receive the discounted promotion price. Those products or services which are not part of the current promotion will not receive a discount. The transaction processor 22 will report the transaction to the credit card company 24 who will in turn send out the appropriate invoice to the buyer 10. The credit card company 24 will be responsible for collecting payments from the buyer 10 and crediting or paying the seller's 20 account, as was explained above with reference to FIG. 3. The buyer 10 may not know that he or she has received the discounted promotional price until they receive their invoice.

As one can ascertain, there are added benefits to contractually signing up to receive one of the issued credit cards and becoming a member of the communication service provider's 14 communication system.

It should be understood that if a potential buyer 10 inputs a certain requirement into the computerized database 16, i.e. locate a seller who sells carpeting within a five mile radius of my house, and the computerized database 16 cannot find a match, then the computerized database 16 could generate a response back to the potential buyer 10. The response could be something like: “No promotional carpeting is available within the distance you specified. Would you like to change the distance you are willing to travel?” If the buyer 10 is willing to increase the distance he or she will travel to a store that is selling promotional carpeting, the buyer 10 will input in a new search parameter. This process can be repeated an infinite number of times.

If the buyer 10 is not satisfied with the above search efforts, the computerized database 16 could ask the buyer 10 something like: “Would you like to be notified when and if the promotional product or service becomes available as part of a special promotion within the distance you are willing to travel?” The buyer 10 could then indicate “yes” or “no”. If the answer is “yes”, then the computerized database 16 would ask the buyer 10 for a time period within which he or she would like to receive such a notice, i.e. 2 weeks, 1 month, six months, etc. The buyer 10 could cancel such notifications at any time.

When the computerized database 16 does not find a promotion on a desired product or service which matches one of the potential buyer's 10 search criteria, for example, within the set distance, the computerized database 16 could return a message something like: “No promotion was located for your desired product or service within the distance you indicated. Would you like to receive a list of sellers 20 that offer the product or service you are looking for and who are located within the stipulated distance?” If the potential buyer 10 is willing to buy the product or service now at the regular sales price, he or she can answer “yes”. The computerized database 16 would then send the potential buyer 10 the names of such sellers 20. For the computerized database 16 to be able to perform this function, it has to have a sufficiently large amount of memory and also must require each of the sellers 20 to input inventory information into it. Some Internet sites which are connected between two businesses have this capability and use packing slip numbers, invoice numbers, etc. to input the information into the database 16. It is conceivable that such an automated system could be incorporated into the computerized database 16 so that it can perform this task.

It should also be understood that the computerized database 16 could have information inputted into it that would include: product specifications, photos, prices, return policies, types of services available, etc. This and other information could be added as is well known to those skilled in the art.

The present method can also include having the computerized database 16 generate a specialized report from information it acquires. The specialized report can indicate how each of the sellers 20 could possibly increase sales by tailoring each of the seller's 20 future offers for a promotional product or service to align with current buying habits and trends of each of the potential buyers 10, and making the specialized report available to each of the sellers 20.

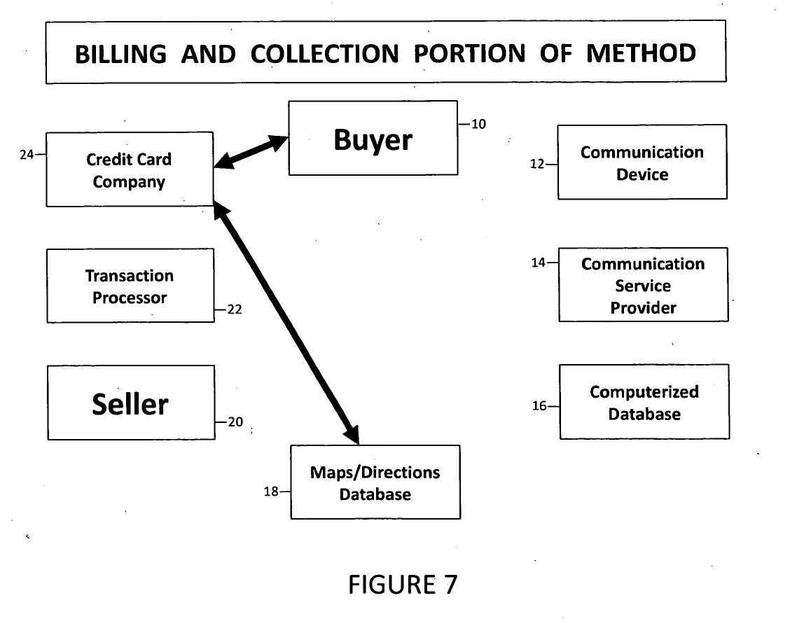

Referring now to FIG. 7, a schematic is shown of the billing and collection portion of the present method. In this portion of the operation, the credit card company 24 sends an invoice to the buyer 10. The invoice will list all purchases made by the buyer 10 within a set time period, i.e. within the last month. The invoice can also list one or more of the following facts: the kind of purchase, the date and time of the purchase, the name of the seller 20, etc. The invoice can also list additional information, such as reward points, reward dollars, coupons available to the buyer 10, etc. The buyer 10 will pay the owed amount to the credit card company 24. The buyer 10 can do this by sending a check or doing an electronic transfer of funds from his or her saving or checking account. If the buyer 10 does not pay or does not fully pay his or her invoice on time, a late fee may be accessed. In addition, the remaining balance may be subject to an interest charge until the remaining balance is paid in full.

The credit card company 24 may also send an invoice to the owner or operator of the maps/directions database 18 provided the owner or operator of the maps/direction database 18 has contractually agreed to pay a fee to be a part of the present method. The owner or operator of the maps/directions database 18 will pay the credit card company 24 the balance it owes or may be subject to a late fee and an interest charge on any outstanding balance. One reason the maps/directions database 18 would want to enter into such a contractual agreement with the credit card company 24 is that the maps/directions database 18 desires additional viewership. By becoming part of the present method, the maps/directions database 18 will be likely to attract additional users. The maps/directions database 18 usually makes its money by selling advertisements on its screen. The more people using its maps/direction database 18 means that it can attract more advertisers and/or charge more money for each advertisement that it places on its screens. The businesses placing the advertisements will be happy because more people will be viewing and hopefully reading their advertisements.

In regard to FIG. 7, it should be understood that the credit card company 24 can be independently owned or be controlled by the communication service provider 14. Alternatively, the credit card company 24 can be owned or controlled by both the owner or operator of the computerized database 16 and by the owner of the communication service provider 14. Depending upon ownership, the invoice could be sent out by one of the other parties instead of by the credit card company 24, if desired.

The present method can include a reward program which would reward and create an incentive for each of the buyers 10 to make additional purchases using his or her issued credit card. The reward system can operate in several different ways. One way is to award a set number of points corresponding to the number of dollars spent on a particular promotional product or service. For example, the buyer 10 may receive one point for each dollar spent. When the buyer 10 purchases various promotional or regular priced products or services, he or she will accumulate additional points. The points can then be used to: reduce the amount of a future invoice send by the credit card company 24; reduce the amount of a future invoice that is due to the communication service provider 14; reduce the cost to upgrade his or her communication device 12; redeem the points by applying them against the purchase price of other promotional products or services; apply the points against the purchase price of non-promotional products or services; redeem the points for cash; or redeem the points in some other fashion. Those skilled in the art will know of other ways to operate a reward system.

It should also be recognized that a reward program could also be created to reward each of the sellers 20 who sells a certain amount of products or services or who generates a certain number of inquires on his promotional products or services that he is offering. The more business that a seller's 20 promotional product or service offer generates, the more points the seller would obtain. In addition, each of the sellers 20 could be awarded points on each promotion placed on the computerized database 16. The more promotions a seller 20 places, the greater number of points he or she will accumulate. Those skilled in the art will know of other ways to operate a reward system.

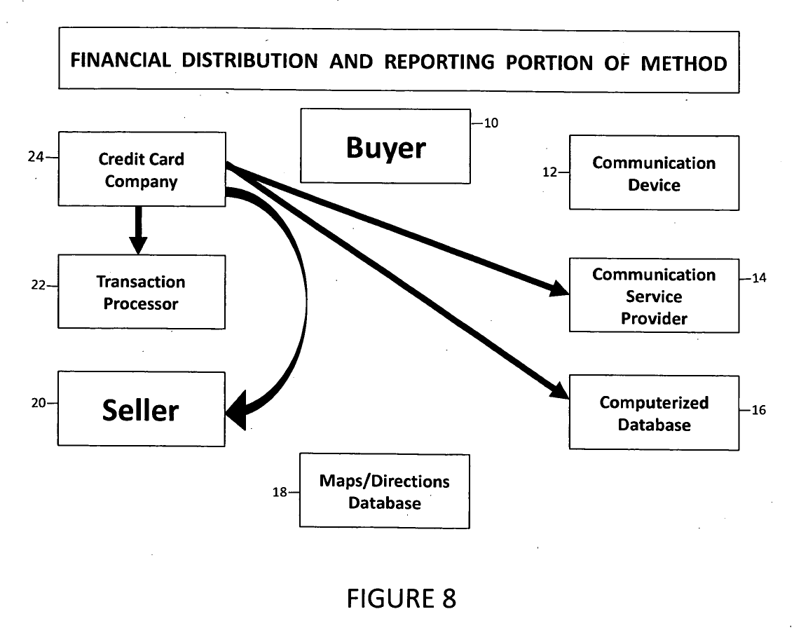

Referring now to FIG. 8, a schematic is shown of the financial distribution and reporting portion of the present method. In this portion of the operation, the credit card company 24 sends payments and reports to the communication service provider 14, to the owner or operator of the computerized database 16, to each of the sellers 20, and to the transaction processor 22. Ideally, the method of buying and selling a promotional product or service should be set up, sponsored or coordinated by either the communication service provider 14 or by the owner or operator of the computerized database 16. As stated above, the tabulated information and/or report which is made available to or sent to each of the sellers 20 could be produced and sent by the credit card company 24, by the communication service provider 14, by the owner or operator of the computerized database 16, or by an independent organization not shown in the schematic but who has been contracted by one of the above-identified parties to prepare and distribute such reports. Alternatively, the tabulated information and/or report could be prepared by the credit card company 24 and be forwarded to any of the above-identified parties. The receiving party could then produce and forward the tabulated information and/or report, or different parts thereof, to each of the sellers 20. The tabulated information and/or report made available to each of the sellers 20 can include factual information about all inquiries as to the current promotional products or services as well as a listing of actual purchases made. In addition, the tabulated information and/or report made available to each of the sellers 20 can include one or more of the following: details of recent promotional activity; demographic profiles (age, income, race, education, marital status, geographic, etc.) and psychographic profiles (hobbies, interests, lifestyles, etc.) of low, medium and high frequency buyers 10; recommendations to improve future promotional offerings; recommendations to improve future promotional designs; recommendations to improve future promotional timing; and other business advise, strategy and information.

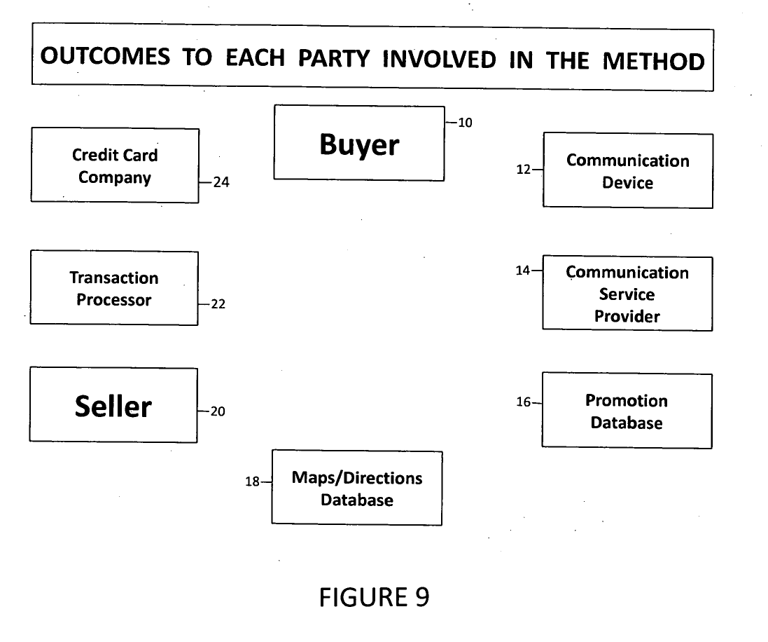

Referring now to FIG. 9, a schematic is shown wherein all the parties using the present method of buying and selling a promotional product or service experience a positive outcome. The buyers 10 receive their desired products or services at a reduced cost. Thus each buyer 10 receives extra value which satisfies the initial requirement of the buyers 10. The buyers 10 become more loyal to the communication service provider 14 and will therefore have an added incentive to renew their future agreements with the communication service provider 14. The buyers 10 may also become repeat customers of one or more of the various sellers 20 who they have done business with.

The company that manufactures and sells the communication devices 12 will have increased sales. Either new buyers 10 who hear good things about the present method will want to sign up and order a communication device 12 directly or the communication service provider 14 will purchase additional communication devices 12 so that it can distribute them to new buyers 10 who sign up with it.

The communication service provider 14 has the potential to gain more customers (potentials buyers 10) both from its competitors as well as from new individuals who want to become a part of the present method. It is human nature that as the promotional buying and selling method gains awareness and popularity, more people will want to join. The communication service provider 14 may also find it easier to retain its current customer (buyers 10). These factors will lead to increase profits.

The owner and/or operator of the computerized database 16 will experience an increase usage of its computerized database 16 and therefore will be able to charge additional fees from the sellers 20 and from the communication service provider 14 and from the maps/directions database 18. This will lead to increase profits.

The owner and/or operator of the map/directions database 18 will receive more exposure to added users (buyers 10) from being a part of the promotional buying and selling method. Because more buyers 10 will want this service, the owner and/or operator of the map/directions database 18 will be able to attract more sponsoring advertisers and command higher fees from sponsoring advertisers. This will translate into increased profits.

The sellers 20 are a main component of the present method. The sellers 20 will receive increased customer awareness, hopefully increased customer traffic, more sales and hopefully repeat buyers 10. The sellers 20 that are subscribers to the communication service provider 14 or to the computerized database 16 may receive promotion registration discounts thus reducing their promotional costs. These factors will translate into increased profits.

The transaction processor 22 gets paid for each transaction it handles. As more potential buyers 10 are drawn to the promotional buying and selling method, the transaction processor 22 will handle additional transactions and thereby will be able to collect more fees. This translates into increased profits.

Lastly, the credit card company 24 also gets paid for each transaction it handles. By processing additional transactions, the credit card company 24 will be able to collect more fees and increase its profits. The bottom line is a win-win for everyone involved in this promotional buying and selling method.

The method of buying and selling a promotional product or service can also include the step of having the communication service provider 14 supplement the computerized database 16 with a printed publication which provides pertinent information on the sellers 20 to the buyers 10. The printed publication can reinforce the information contained in the computerized database 16. The pertinent information can include information on the buyers 10, the sellers 20 or both. The pertinent information can include but is not limited to: the names, addresses and phone numbers of the buyers 10 and the sellers 20. The pertinent information can also list the products or services offered for sale by the sellers 20. Additional information can also be listed. For example, if a person is a lawyer, a doctor, a dentist, an accountant, etc. his or her professional expertise can be listed if they are actively practicing in that profession. Furthermore, the pertinent information can be listed in alphabetical order by surnames, as well as being grouped by categories or topics to make it easy for one using the printed publication to find all sellers 20 of a particular product, i.e. carpeting. The communication service provider 14, whether a major telecommunication company such as AT&T, Verizon, T-Mobile, Bell South, etc.; an intermediate size telecommunication company; or a smaller company such as a local telecommunication company, can publish the printed booklet. The printed publication can be actually prepared by a third party who specializes in printing directories, books, magazines, etc. As an example, AT&T owns, publishes and distributes the YELLOW PAGES®. The actual printed YELLOW PAGES® can be the supplement to the computerized database 16.

The printed publication can be distributed to everyone, to only the potential buyers 10, or to a select group of people. For example, the printed publication can be distributed to all potential buyers 10 who have a hard wired telephone service. The printed publication, i.e. the YELLOW PAGES®, can assist the potential buyers 10 in deciding what key words or topics they should enter in their communication devices 12 in order to start their search for sellers 20 of a particular product or service.

Likewise, the method of buying and selling a promotional product or service can also include the step of having the communication service provider 14 supplement the computerized database 16 with additional information relating to the sellers 20 through a second communication system which is electronically available to the buyers 10. The second communication system can include another computerized database.

While the invention has been described in conjunction with several specific embodiments, it is to be understood that many alternatives, modifications and variations will be apparent to those skilled in the art in light of the foregoing description. Accordingly, this invention is intended to embrace all such alternatives, modifications and variations which fall within the spirit and scope of the appended claims.

I claim:

1. A method of buying and selling a promotional product or service, said method comprising the steps of:
a) identifying a potential buyer who is willing to seek a promotional product or service at a price below a regular list price, said potential buyer having a communication device which can be activated;
b) connecting said communication device to a communication system, said communication system controlled by a communication service provider who has contractually agreed with said potential buyer to provide a connection covering a specific geographical area;
c) identifying a seller who is willing to sell a promotional product or service at a price below a regular list price, said seller having contractually agreed with a database owner to input specific information into a computerized database relating to said promotional product or service which is to be offered by said seller, said computerized database capable of receiving and storing said specific information, and distributing select information over said communication system on a real time basis to said potential buyer when prompted by said activated communication device;
d) tabulating information acquired by said computerized database indicating when said potential buyer accessed said computerized database to review said promotional product or service offered by said seller and recording that said potential buyer actually bought said promotional product or service from said seller; and
e) providing said tabulated information to said seller.

2. The method of claim 1 further comprising a plurality of potential buyers, each of said potential buyers having a communication device and each of said potential buyers having contractually agreed with said communication service provider to have said communication device connected to said communication system, and a plurality of sellers, each of said sellers having contractually agreed with said database owner to input specific information into said computerized database relating to said promotional product or service offered by said seller, said multiple potential buyers including both individual and business buyers, and said multiple sellers including individuals, agents, middlemen, wholesalers, retailers, merchants, manufacturers and jobbers.

3. The method of claim 2 further comprising the step of having said communication service provider contract with a credit card company who is capable of issuing a credit card to each of said plurality of potential buyers, said credit card providing a way for each of said potential buyers to purchase said promotional product or service from one of said plurality of sellers at a price below a regular list price.

4. The method of claim 3 further comprising the step of having said credit card company contract with a transaction processor who is capable of processing all financial transactions between each of said plurality of potential buyers and each of said plurality of sellers, said transaction processor reporting each transaction to said credit card company and said credit card company preparing and sending an invoice to each of said potential buyers on a regular basis who has made a purchase of any of said promotional products or services from any of said plurality of sellers, and said credit card company receiving payments from each of said plurality of buyers who has made a purchase and crediting said payment to said seller of said promotional product or service.

5. The method of claim 1 wherein said communication device is a cell phone which is connected to said communication system by a wireless connection.

6. The method of claim 5 further comprising the step of adding a global positioning system and a monitor to said communication device and adding maps and directional information into said computerized database to enable said computerized database to provide said potential buyer with maps and directions from said potential buyer's current position to said seller's business location when said communication device is activated and connected to said computerized database.

7. The method of claim 1 wherein said potential buyer can review said select information in said computerized database by dialing into said computerized database using said communication device, and said select information includes at least one of the following: a listing of kinds and types of promotional products or services offered for sale by said seller, a location of said seller's business, directions to said seller's business from a current location, a time when said seller is open for business, a time zone in which said seller's business is located, a listing of credit cards accepted by said seller, a notice of any conditions imposed by said seller which must be met by said potential buyer to qualify for said promotional products or services, a notice of handicap accessibility to said seller's business, a notice of a smoking/non-smoking policy at said seller's business, and a notice of whether a pet is permitted in said seller's business.

8. The method of claim 1 further comprising the step of having said communication service provider supplement said computerized database with a printed publication which provides pertinent information relating to said seller.

9. The method of claim 1 further comprising the step of having said communication service provider supplement said computerized database with additional information relating to said seller through a second communication system which is electronically available to said buyer.

10. A method of buying and selling a promotional product or service, said method comprising the steps of:
a) identifying a plurality of potential buyers each of whom is willing to seek a promotional product or service at a price below a regular list price, each of said potential buyers having a communication device which can be activated;
b) connecting each of said communication devices to a communication system, said communication system controlled by a communication service provider who has contractually agreed with each of said potential buyers to provide a wireless connection covering a specific geographical area;
c) identifying a plurality of sellers each of whom is willing to offer a promotional product or service at a price below a regular list price, each of said sellers having contractually agreed with a database owner to input specific information into a computerized database relating to said promotional product or service which is to be offered by each of said sellers, said computerized database capable of receiving and storing said specific information, and distributing select information over said communication system on a real time basis to each of said potential buyers when prompted by each of said activated communication devices;
d) generating a report from information acquired by said computerized database indicating when each of said potential buyers has accessed said computerized database to review said promotional product or service offered by each of said sellers and reporting that at least one of said potential buyers has actually bought a promotional product or service from one of said sellers;
e) providing said report to each of said sellers on a regular basis; and
f) having said communication service provider supplement said computerized database with a printed publication which provides pertinent information on said sellers to said buyers.

11. The method of claim 10 further comprising the step of having each of said sellers input specific information into said computerized database on a current promotional product or service using the Internet.

12. The method of claim 10 further comprising the step of having said communication service provider contract with a credit card company who is capable of issuing a credit card to each of said potential buyers, said credit card allowing each of said potential buyers to purchase a promotional product or service from one of said sellers at a price below a regular list price, and said credit card company contracts with a transaction processing company who is capable of processing all financial transactions between each of said buyers and each of said sellers, said credit card company preparing and sending an invoice to each of said buyers on a regular basis for all purchases of said promotional products or services from each of said sellers, crediting each of said sellers with a payment for products or services sold, and receiving payments from each of said buyers.

13. The method of claim 12 further comprising the step of having said credit card company generate a report to said communication service provider, to said computerized database owner and to each of said sellers on a regular basis for all purchases of said promotional products or services involving one of said issued credit cards, and distributing appropriate moneys to said communication service provider and to said computerized database owner for connections made to said computerized database using said communication system and to each of said sellers for each actual purchase of one of said promotional products or services made.

14. The method of claim 10 further comprising the step of adding a global positioning system and a monitor to each of said communication devices and adding maps and directional information into said computerized database to enable said computerized database to provide each of said potential buyers with maps and directions from a location where a potential buyer is to one of said seller's business locations when said communication device is activated and connected to said computerized database.

15. The method of claim 10 wherein said communication device is a smart cell phone which is connected to said communication system by a wireless connection.

16. A method of buying and selling a promotional product or service, said method comprising the steps of:
a) identifying a plurality of potential buyers each of whom is willing to seek a promotional product or service at a price below a regular list price, each of said potential buyers having a communication device which can be activated at a predetermined time;
b) connecting each of said communication devices to a communication system, said communication system controlled by a communication service provider who has contractually agreed with each of said potential buyers to provide a wireless connection covering a specific geographical area;
c) identifying a plurality of sellers each of whom is willing to offer a promotional product or service at a price below a regular list price, each of said sellers having contractually agreed with a database owner to input specific information into a computerized database relating to said promotional product or service offered by each of said sellers, said computerized database capable of receiving and storing said specific information, and distributing select information over said communication system on a real time basis to each of said potential buyers when prompted by said activated communication device;
d) having said communication service provider contract with a credit card company who is capable of issuing a credit card to each of said buyers, said credit card allowing each of said buyers to purchase said promotional products or services from each of said sellers at a price below regular list price, and said credit card company contracts with a transaction processing company who is capable of processing all financial transactions between each of said buyers and each of said sellers, said credit card company preparing and sending an invoice to each of said buyers on a regular basis for all purchases of said promotional products or services from each of said sellers, receiving payments from each of said buyers and crediting each of said sellers with corresponding payments;
e) generating a report from information acquired by said computerized database indicating when each of said potential buyers has accessed said computerized database to review said promotional product or service offered by each of said sellers and reporting that at least one of said potential buyers has actually bought a promotional product or service from one of said sellers;
f) printing said report;
g) making said printed report available to each of said sellers on a regular basis; and
h) having said communication service provider supplement said computerized database with a second communication system which provides pertinent information on said sellers to said buyers.

17. The method of claim 16 wherein each of said potential buyers activates and connects his communication device to said communication system, and accesses said computerized database by making entries using a keyboard, by clicking on prearranged menus or by voice recognition.

18. The method of claim 16 further comprising the step of supplementing each of said reports with additional information advising each of said sellers how to improve future promotional product or service offerings so as to increase potential sales.

19. The method of claim 16 further comprising the step of rewarding each of said buyers with a predetermined number of points based upon the dollar amount of purchases made by each of said buyers, and said points being redeemable for cash, products or services available from any one of said sellers.

20. The method of claim 16 further comprising the step of having said computerized database generate a specialized report from information it acquires, said specialized report indicating how each of said sellers could possibly increase sales by tailoring each of said seller's future offers for a promotional product or service to align with current buying habits and trends of each of said buyers, and making said specialized report available to each of said sellers.
